(19) United States
(12) Patent Application Publication
(10) Pub. No.: US 2014/0205100 A1
(43) Pub. Date: Jul. 24, 2014

(54) METHOD AND AN APPARATUS FOR GENERATING AN ACOUSTIC SIGNAL WITH AN ENHANCED SPATIAL EFFECT

(71) Applicant: Huawei Technologies Co., Ltd., Shenzhen (CN)

(72) Inventors: Christof Faller, St-sulpice (SE); David Virette, Munich (DE); Yue Lang, Munich (DE)

(73) Assignee: Huawei Technologies Co., Ltd., Shenzhen (CN)

(21) Appl. No.: 14/219,620

(22) Filed: Mar. 19, 2014

Related U.S. Application Data
(63) Continuation of application No. PCT/CN2011/079806, filed on Sep. 19, 2011.

(51) Int. Cl. H04S 7/00

(52) U.S. Cl. CPC H04S 7/307
USPC 381/17

(57) ABSTRACT

An apparatus and a method for generating an acoustic signal with an enhanced spatial effect, said apparatus comprising a signal filter bank adapted to filter a difference audio signal with a filter characteristic to limit a bandwidth of said difference audio signal, wherein said bandwidth limited difference audio signal is applied to at least one pair of loudspeakers for dipole sound emission.

### CROSS-REFERENCE TO RELATED APPLICATIONS

This application is a continuation of International Application No. PCT/CN2011/079806, filed on Sep. 19, 2011, which is hereby incorporated by reference in their entirety.

### TECHNICAL FIELD

The application relates to a method and an apparatus for generating an acoustic signal with an enhanced spatial effect and to a mobile device comprising such an apparatus.

### BACKGROUND

Acoustic signals for users are generated by loudspeakers in response to an electrical audio signal output by an audio signal source. For example, a stereo signal comprising a left and right audio signal is supplied to two loudspeakers spaced apart by a distance and pointing to a user listening to the acoustic signal. Normally, the loudspeakers receiving the stereo audio signal are positioned away from each other so that the listening user can perceive an audio image which allows him for example to locate the position of different music instruments within an orchestra when a classical stereo music signal is recorded. However, this room experience of the listening user is restricted to the distance between the loudspeakers and no spatial effect is achieved beyond the distance of the two loudspeakers transforming the stereo audio signal into an acoustic sound signal.

Other systems have been proposed to increase the spatial sound experience for a user listening to an acoustic signal generated in response to an audio signal. A conventional known arrangement is for example a 5.1 surround sound multi-channel audio system which is most commonly used in commercial cinemas and home theatres. The conventional 5.1 inner surround sound multi-channel audio system uses five full bandwidth channels and one low-frequency enhancement channel. The 5.1 surround sound multi-channel audio system is designed to provide a proper localization of all acoustic sources for a listening user being positioned at the sweet spot in the centre between the five loudspeakers as shown in FIG. 1.

However, the conventional audio system as shown in FIG. 1 has some drawbacks. Placing the loudspeakers to meet the requirements of the surround sound multi-channel audio system is often at odds with the space constraints of a normal room such as an average living room. Furthermore, in many applications it is not possible to position loudspeakers around a user. In particular for mobile devices such as mobile phones having integrated loudspeakers, the positioning of loudspeakers around a listening user is not possible.

Accordingly, it is an object of the present application to provide a method and an apparatus for generating an acoustic signal with an enhanced spatial effect going beyond the distance between the loudspeakers without the necessity of positioning loudspeakers around a listening user.

### SUMMARY

According to a first aspect of the present application an apparatus for generating an acoustic signal with an enhanced spatial effect is provided, wherein the apparatus comprises:

at least one signal filter bank adapted to filter a difference audio signal with a filter characteristic to limit a bandwidth of said difference audio signal,

wherein said bandwidth limited difference audio signal is applied to at least one pair of loudspeakers for dipole sound emission.

In a first implementation of the apparatus being a possible implementation of the apparatus according to the first aspect the bandwidth limited difference signal is inverted before being applied to a first loudspeaker of said pair of loudspeakers and is applied directly to a second loudspeaker of the pair of loudspeakers.

In a second implementation of the apparatus being a possible implementation of said apparatus according to the first aspect as such or according to its first implementation the apparatus comprises a signal subtractor adapted to subtract a first audio signal from a second audio signal to provide said difference audio signal.

In a third implementation of the apparatus being a possible implementation of said apparatus according to the first aspect as such or according to its first or second implementation the at least one signal filter bank comprises filters each being adapted to filter an associated frequency subband of the difference audio signal.

In a fourth implementation of the apparatus being a possible implementation of the third implementation of the apparatus according to the first aspect for each frequency subband of said signal filter bank a corresponding pair of loudspeakers is provided.

In a fifth implementation of the apparatus being a possible implementation of the fourth implementation of the apparatus according to the first aspect the bandwidth limited difference audio signal output by a filter of said signal filter bank provided for a low frequency subband is subtracted from the first audio signal to provide a first input audio signal for the first loudspeaker of said dipole sound emitting loudspeaker pair.

In a sixth implementation of the apparatus being a possible implementation of the fourth or fifth implementation of the apparatus according to the first aspect the bandwidth limited difference audio signal output by a filter of said signal filter bank provided for a low frequency subband is added to the second audio signal to provide a second input audio signal for the second loudspeaker of said dipole sound emitting loudspeaker pair.

In a seventh implementation of the apparatus being a possible implementation of the fourth implementation of the apparatus according to the first aspect the bandwidth limited difference audio signal output by a filter of the signal filter bank provided for a high frequency subband is applied directly to a further loudspeaker pair, comprising left and right pointing loudspeakers.

In an eighth implementation of the apparatus being a possible implementation of the apparatus according to the first aspect as such or any of its first to seventh implementations the filters of the signal filter bank comprise Infinite Impulse Response IIR filters.

In a ninth implementation of the apparatus being a possible implementation of the apparatus according to the first aspect as such or any of its first to seventh implementations the filters of the signal filter bank comprise Finite Impulse Response FIR filters.

In a tenth implementation of the apparatus being a possible implementation of the apparatus according to the first aspect as such or any of its first to ninth implementations the filters of the at least one signal filter bank are adapted to equalize a diffuse frequency response of the loudspeaker pairs.

In an eleventh implementation of the apparatus being a possible implementation of the apparatus according to the first aspect as such or any of its first to tenth implementations to each filter of the signal filter bank a further filter is connected in series.

In a twelfth implementation of the apparatus being a possible implementation of the apparatus according to the first aspect as such or any of its first to eleventh implementations the two loudspeakers of a loudspeaker pair are spaced apart at a predetermined distance around a symmetry axis.

In a thirteenth implementation of the apparatus being a possible implementation of the twelfth implementation of the apparatus according to the first aspect a centre frequency of the frequency subband of the dipole sound emitting loudspeaker pair provided for the respective frequency subband is set depending on said distance.

In a fourteenth implementation of the apparatus being a possible implementation of the thirteenth implementation of the apparatus according to the first aspect the centre frequency of the frequency subband of the dipole sound emitting loudspeaker pair provided for the respective frequency subband is lowered with increasing distance between the loudspeakers of the dipole sound emitting loudspeaker.

In a fifteenth implementation of the apparatus being a possible implementation of the apparatus according to the first aspect as such or any of its first to fourteenth implementations the at least one signal filter bank comprises a predetermined filter characteristic.

In a sixteenth implementation of the apparatus being a possible implementation of the apparatus according to the first aspect as such or any of its first to fifteenth implementations the at least one signal filter bank comprises an adjustable filter characteristic.

In a seventeenth implementation of the apparatus being a possible implementation of the apparatus according to the first aspect as such or any of its aforementioned implementations the apparatus comprises a first and a second loudspeaker pair and the at least one signal filter bank comprises a first filter and a second filter, wherein the first filter is adapted to filter a first frequency subband of the difference audio signal to provide a first bandwidth limited signal, wherein the second filter is adapted to filter a second frequency subband of the difference audio signal to provide a second bandwidth limited signal, which has a different centre frequency and/or bandwidth limitation than the first bandwidth limited signal, and wherein the first bandwidth limited signal is provided to the first loudspeaker pair and the second bandwidth limited signal is provided to the second loudspeaker pair.

In an eighteenth implementation of the apparatus being a possible implementation of the seventeenth implementation of the apparatus according to the first aspect, the first bandwidth limited signal is not provided to the second loudspeaker pair and the second bandwidth limited signal is not provided to the first loudspeaker pair.

In a nineteenth implementation of the apparatus being a possible implementation of the seventeenth or eighteenth implementation of the apparatus according to the first aspect, wherein the two loudspeakers of the first loudspeaker pair are spaced apart at a predetermined first distance around a symmetry axis and the two loudspeakers of the second loudspeaker pair are spaced apart at a predetermined second distance around the symmetry axis, wherein the second distance is larger than the first distance and a centre frequency of the second filter is smaller than a centre frequency of the first filter.

The respective means, in particular the filter banks and filters, the inverters, the signal subtractors and the signal adders are functional entities and can be implemented in hardware, software or combinations of both, as is known to persons skilled in the art. If said means are embodied in hardware they may be implemented as a device or as part of a system, and may be embodied, for example, as discrete units, integrated circuits or as a processor. If said means are implemented in software they may be embodied as a computer program product, as a function, as a routine, as a program code or as an executable object.

According to a second aspect of the present application a mobile device is provided comprising an apparatus for generating an acoustic signal with an enhanced spatial effect according to the first aspect of the present application or any of its aforementioned implementations.

According to a third aspect of the present application a soundbar is provided comprising an apparatus for generating an acoustic signal with an enhanced spatial effect according to the first aspect of the present application or any of its aforementioned implementations.

According to a fourth aspect of the present application a docking station is provided comprising an apparatus for generating an acoustic signal with an enhanced spatial effect according to the first aspect of the present application or any of its aforementioned implementations.

According to a fifth aspect of the present application a method for generating an acoustic signal with an enhanced spatial effect is provided, wherein the method comprises the steps of:
filtering a difference audio signal with a filter characteristic to limit a bandwidth of said difference audio signal; and
applying said bandwidth limited difference audio signal to at least one pair of loudspeakers for dipole sound emission.

### BRIEF DESCRIPTION OF THE DRAWINGS

In the following possible implementations two of the different aspects of the present application are described in more detail with reference to the enclosed figures.

FIG. 1 shows a diagram for illustrating a conventional 5.1 surround sound multi-channel audio system;

FIG. 2 shows a block diagram of a possible implementation of an apparatus for generating an acoustic signal with an enhanced spatial effect according to the first aspect of the present application;

FIGS. 3, 4, 5 show different possible implementations of an apparatus for generating an acoustic signal with an enhanced spatial effect according to the first aspect of the present application;

FIG. 6 shows a block diagram of a possible implementation of an apparatus for generating an acoustic signal with an enhanced spatial effect according to the first aspect of the present application;

FIG. 7 shows a diagram for illustrating a frequency response of a signal filter bank used in an implementation of an apparatus for generating an acoustic signal with an enhanced spatial effect according to the first aspect of the present application as shown in FIG. 6.;

FIG. 8 shows a diagram for illustrating a further possible implementation of an apparatus for generating an acoustic signal with an enhanced spatial effect according to the first aspect of the present application;

FIG. 9 shows a diagram for illustrating different reproduction means for different frequency regions used by the apparatus for generating an acoustic signal with an enhanced spatial effect according to the first aspect of the present application as shown in FIG. 8;

FIG. 10 shows a diagram for illustrating direction characteristics of loudspeakers for a dipole sound emission with a specific distance between the loudspeakers to illustrate a possible implementation of an apparatus for generating an acoustic signal with an enhanced spatial effect according to the first aspect of the present application;

FIG. 11 shows a further diagram for illustrating directional characteristics of loudspeakers for dipole sound emission with a specific distance between the loudspeakers used in a further possible implementation of an apparatus for generating an acoustic signal with an enhanced spatial effect according to the first aspect of the present application;

FIG. 12 shows a diagram for illustrating diffuse field responses to illustrate an impact of shelving correction filters as used in a possible implementation of an apparatus for generating an acoustic signal with an enhanced spatial effect according to the first aspect of the present application;

FIG. 13 shows a flow chart for illustrating a possible implementation of a method for generating an acoustic signal with an enhanced spatial effect according to the fourth aspect of the present application;

FIG. 14 shows a perspective view of a mobile device comprising an apparatus for generating an acoustic signal according to the second aspect of the present application;

FIG. 15 shows a diagram for illustrating directivity increase of loudspeakers with increasing frequency, wherein that effect shown is used in an apparatus for generating an acoustic signal with an enhanced spatial effect and by a method for generating an acoustic signal with an enhanced spatial effect according to the first and fourth aspect of the present application;

FIG. 16 shows a diagram for illustrating definitions of a coordinate system and angles in which direction responses can be defined; and

FIG. 17 shows a diagram for illustrating a directional response of a dipole loudspeaker which can be implemented by a pair of loudspeakers for dipole sound emission as used by an apparatus for generating an acoustic signal with an enhanced spatial effect according to the first aspect of the present application.

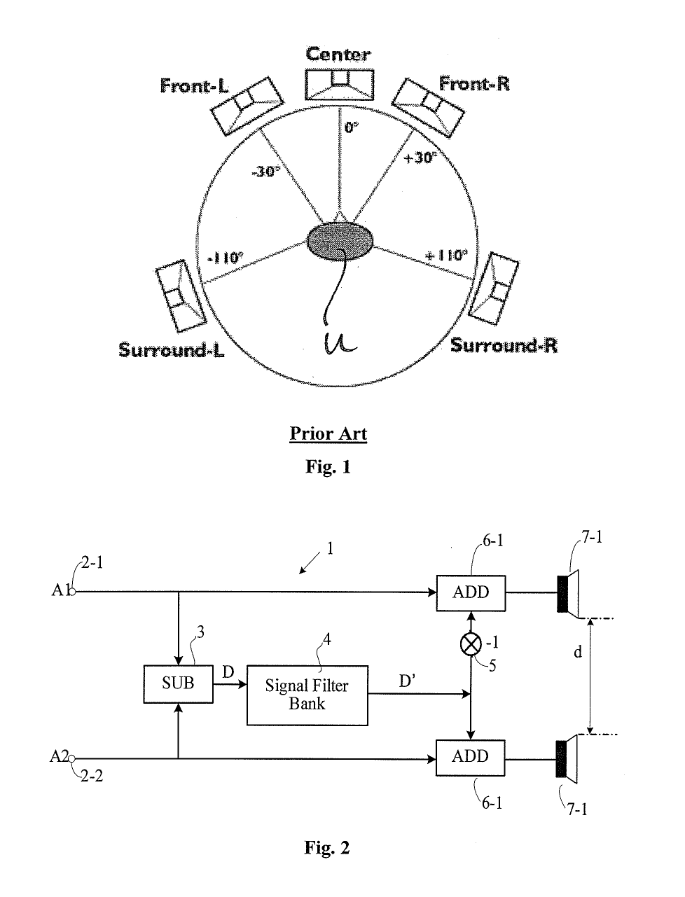

### DETAILED DESCRIPTION

FIG. 2 shows a possible implementation of an apparatus 1 for generating an acoustic signal with an enhanced spatial effect according to the first aspect of the present application. The acoustic signal may be directed to a listening user U as shown in FIG. 2.

The implementation shown in FIG. 2 of the apparatus 1 comprises two signal inputs 2-1, 2-2 to which a first and a second audio signal A1, A2 are applied. The first and second audio signals A1, A2 can be output by different audio signal sources. For example, the two audio signals A1, A2 can be a first and second audio signal of a stereo audio signal output by a stereo signal audio source. The implementation shown in FIG. 2 of the apparatus 1 comprises a signal subtractor 3 adapted to subtract the first audio signal A1 from the second audio signal A2 to provide a difference audio signal D as shown in FIG. 2. The apparatus 1 further comprises at least one signal filter bank 4 adapted to filter the difference audio signal D with a filter characteristic to limit a bandwidth of the difference audio signal D. The filter bank 4 outputs a bandwidth limited difference audio signal D′ as can be seen in FIG. 2. The bandwidth limited difference audio signal D′ is inverted in the shown implementation by signal inverting means 5. The signal inverting means 5 can be formed by a multiplier multiplying the bandwidth limited difference audio signal D′ with a negative value of −1. The inverted bandwidth limited difference audio signal is added to the first audio signal A1 applied to the first input 2-1 of the apparatus 1 by means of a first signal adder 6-1 as shown in FIG. 2. On the other hand, the bandwidth limited difference audio signal D′ is directly added to the second audio signal A2 by means of a second signal adder 6-2 as shown in FIG. 2. The input signal of the first signal adder 6-1 is applied to the input of the first loudspeaker 7-1 of the pair of loudspeakers 7 shown in FIG. 2. Moreover, the output signal of the second signal adder 6-2 is applied to the input of the second loudspeaker 7-2 of said that pair of loudspeakers 7-1, 7-2. The loudspeakers 7-1, 7-2 form a pair of loudspeakers for dipole sound emission. The pair of loudspeakers 7-1, 7-2 used by the apparatus 1 is provided for a dipole sound emission, i.e. they mimic a dipole loudspeaker, dipole being derived from the fact that a polar response is of two equal radiation forwards and backwards, particular to the access.

The signal filter bank 4 of the apparatus 1 shown in FIG. 2 comprises in a possible implementation filters each being adapted to filter an associated frequency subband SB of the difference audio signal D applied to the signal filter bank 4. For each frequency subband SB of the signal filter bank 4 a corresponding pair of loudspeakers can be provided. In the implementation shown in FIG. 2 the signal filter bank 4 is only provided for one frequency subband. The filters of the signal filter bank 4 can be formed by infinite impulse response IIR filters. In an alternative implementation the filters of the signal filter bank 4 can comprise finite impulse response FIR filters as well. To each filter of the signal filter bank 4 a further signal filter can be connected in series. In a possible implementation the two loudspeakers 7-1, 7-2 of the loudspeaker pair 7 are spaced apart at a predetermined distance d around a symmetry axis as illustrated in FIGS. 2 to 5. In a possible implementation the distance d between the loudspeakers 7-1, 7-2 of the dipole sound emitting loudspeaker pair 7-1, 7-2 is set depending on a centre frequency of the frequency subband SB of the dipole sound emitting loudspeaker pair 7 provided for the respective frequency subband. With lowering centre frequency fc of the frequency subband SB the distance d between the loudspeakers 7-1, 7-2 is set to higher distance values. In a possible implementation the centre frequency fc of the dipole sound emitting loudspeaker pair 7-1, 7-2 provided for the respective frequency subband SB is lowered with increasing distance d between the loudspeakers of the dipole sound emitting loudspeaker pair. In a further possible implementation of the apparatus 1 according to the first aspect of the present application the distance d between the loudspeakers 7-1, 7-2 of the dipole sound emitting loudspeaker pair 7 can be adjusted and the loudspeakers 7-1, 7-2 can be moved with respect to each other around a symmetry axis. In this specific implementation the distance d between the movable loudspeakers of the dipole sound emitting loudspeaker pair 7-1, 7-2 can be increased with lowering centre frequency fc of the frequency subband SB of the dipole sound emitting loudspeaker pair 7 provided for the respective frequency subband. The movement of the loudspeakers 7-1, 7-2 with respect to each other can be controlled in this specific implementation by a control unit.

In a possible implementation of the apparatus 1 for generating an acoustic signal with an enhanced spatial effect according to the first aspect of the present application the signal filter bank 4 comprises a predetermined preset filter characteristic. In an alternative implementation of the apparatus 1 according to the first aspect of the present application the signal filter bank 4 comprises an adjustable filter characteristic. In a possible implementation the adjustable filter characteristic can be adjusted by a filter characteristic adjusting unit via an interface of the apparatus 1.

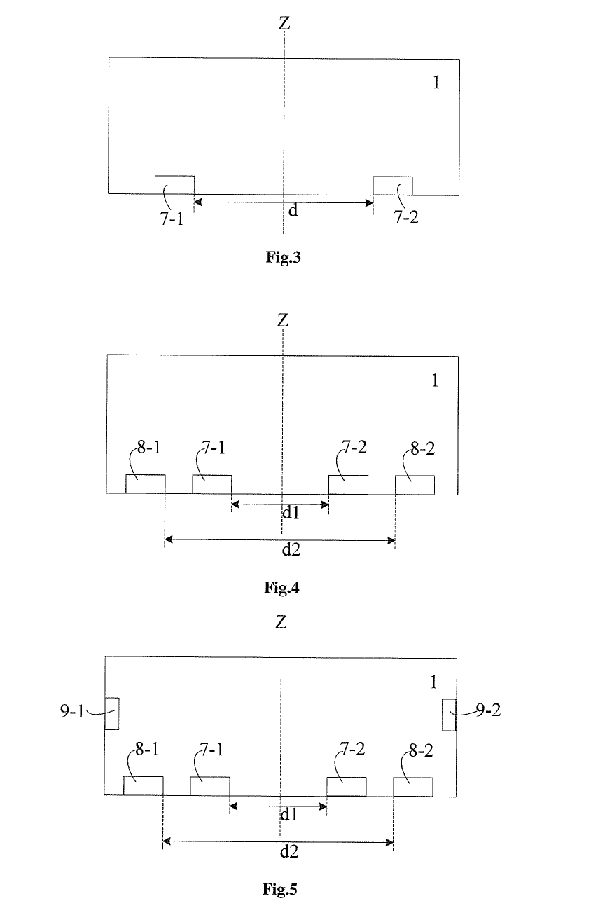

FIGS. 3, 4, 5 show different possible implementations of an apparatus 1 for generating an acoustic signal with an enhanced spatial effect according to the first aspect of the present application. The implementation shown in FIG. 3 comprises a single pair of loudspeakers 7-1,

7-2 for dipole sound emission spaced apart at a distance d around a symmetry axis Z. The implementation of the apparatus 1 as shown in the diagram of FIG. 3 corresponds to the implementation shown in FIG. 2.

FIG. 4 shows a further possible implementation of an apparatus for generating an acoustic signal comprising two pairs of loudspeakers 7-1, 7-2 and 8-1, 8-2. A first pair of loudspeakers for dipole sound emission 7-1, 7-2 is spaced apart at a distance d1 around the symmetry axis Z. A second pair of loudspeaker 8-1, 8-2 for dipole sound emission is spaced apart at a distance d2 around the same symmetry axis Z as shown in FIG. 4. The first and second pair of loudspeakers for dipole sound emission 7, 8 shown in FIG. 4 are pointing both towards a user U which is positioned in front of the apparatus 1 listening to the generated acoustic signal.

FIG. 5 shows a further possible implementation of an apparatus 1 for generating an acoustic signal within an enhanced spatial effect according to the first aspect of the present application comprising a loudspeaker pair 9-1, 9-2 pointing left and right perpendicular to the symmetry axis Z. Whereas the first loudspeaker pair 7-1, 7-2 and the second loudspeaker pair 8-1, 8-2 are located at a front side of the apparatus 1 pointing to a listening user U and provided for dipole sound emission, the additional pair of loudspeakers 9-1, 9-2 is provided for a high frequency subband and is not provided for dipole sound emission. In an alternative implementation the two loudspeakers 9-1, 9-2 of the loudspeaker pair located at the distal ends of the apparatus 1 can also be loudspeakers for dipole sound emission.

In possible implementations the apparatus 1 for generating an acoustic signal with an enhanced spatial effect as shown in the FIGS. 3, 4, 5 can be integrated in a sound bar or a mobile device. The mobile device can be for example a mobile phone, a smart phone, a tablet etc.

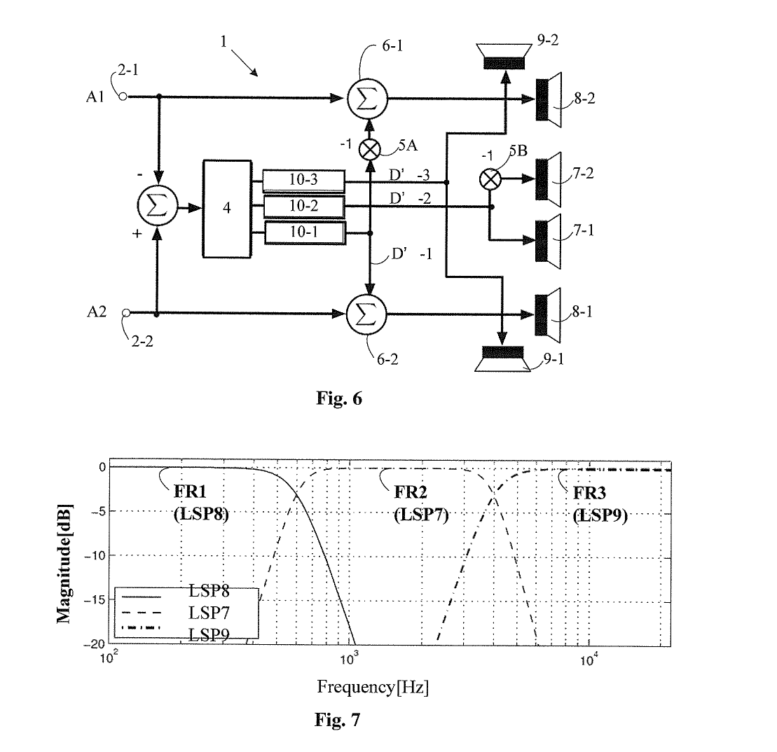

FIG. 6 shows a possible implementation of the apparatus 1 for generating an acoustic signal within an enhanced spatial effect according to the first aspect of the present application. The implementation shown in FIG. 6 comprises three pairs of loudspeakers 7, 8, 9 similar to the implementation shown in FIG. 5. In the implementation of FIG. 6 the signal filter bank 4 comprises three integrated IIR filters to which the audio signal D is supplied by the subtractor 3 and which filter the applied audio difference signal D according to a filter characteristic. In the specific implementation shown in FIG. 6 to each signal filter of the filter bank 4 a further IIR filter 10-1, 10-2, 10-3 is connected in series.

FIG. 7 shows the frequency responses of the integrated IIR filters within the signal filter bank 4 shown in FIG. 6. The signal filter bank 4 comprises filters each being adapted to filter an associated frequency subband SB of the applied difference audio signal D. In the shown implementation of FIG. 6 the signal filter bank 4 comprises three integrated IIR filters being adapted to filter an associated frequency subband SB of the difference audio signal D. A first signal filter integrated within the signal filter bank 4 is provided for a first low frequency subband SB and comprises the frequency response FR1 shown in FIG. 7. A second signal filter in the signal filter bank 4 is provided for a second middle frequency subband SB and comprises a filter response FR2 as shown in FIG. 7. A third signal filter integrated in the signal filter bank 4 is provided to a third high frequency subband SB and comprises the filter response FR3 as shown in FIG. 7.

The filtered signal of the first signal filter within the signal filter bank 4 with the frequency response FR1 is output to an IIR filter 10-1 from the signal filter bank 4. The bandwidth limited difference audio signal D′-1 output by the IIR-filter 10-1 is inverted by inverting means 5A and added to the first audio signal A1 by means of the first signal adder 6-1 as shown in FIG. 6. The bandwidth limited difference audio signal DT-1 output by the signal filter 10-1 is applied directly to the second signal adder 6-2 and added to the second audio signal A2 as shown in FIG. 6. The first and second audio signal A1, A2 can be in a possible implementation a left and right input signal of a stereo signal applied to the apparatus 1. The output signal of the first signal adder 6-1 and the output signal of the second signal adder 6-2 are applied directly to the input of the loudspeaker pair 8-1, 8-2 for dipole sound emission.

The filtered output signal outputted by the second filter integrated in the signal filter 4 can be further filtered by the IIR filter 10-2 to equalize the diffuse frequency response of the corresponding loudspeaker pairs in the bandwidth limited difference audio signal D′-2 that can be inverted by an inverter 5B to be applied to the loudspeaker 7-2 and directly applied to the other loudspeaker 7-1 of this loudspeaker pair 7.

The bandwidth limited difference audio signal output by the third filter of the signal filter bank 4 is further filtered by the IIR filter 10-3 and directly applied as the bandwidth limited difference audio signal D′-3 to a further loudspeaker pair 9 comprising left and right pointing loudspeakers 9-1, 9-2 as shown in FIG. 6. The bandwidth limited difference audio signal D′-3 is provided for a high frequency subband.

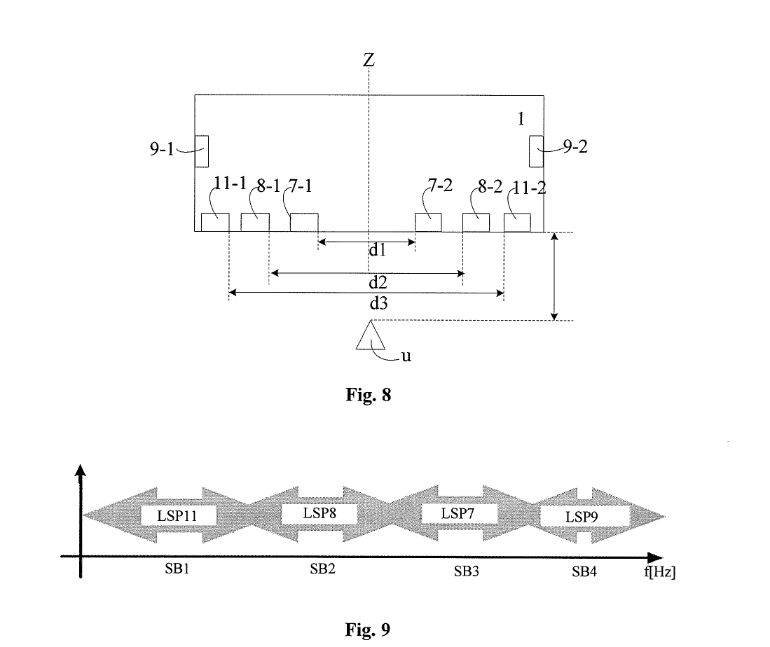

FIG. 8 shows a further possible implementation of an apparatus 1 for generating an acoustic signal within an enhanced spatial effect comprising three pairs of loudspeakers 7, 8, 11 provided for dipole sound emission and pointing towards a user U as shown in FIG. 8. The apparatus 1 comprises a further loudspeaker pair 9 comprising left and right pointing loudspeakers 9-1, 9-2 located around a symmetry axis Z as shown in FIG. 8. The pairs of loudspeakers 7, 8, 11 are provided for dipole sound emission where loudspeakers of these pairs 7, 8, 11 are spaced apart a predetermined distances d1, d2, d3 respectively as shown in FIG. 8. A distance A between the front side of the apparatus 1 as shown in FIG. 8 and a user U can vary. The user U can be positioned along of the symmetry axis Z as shown in FIG. 8.

FIG. 9 shows a diagram for illustrating the use of different reproduction means of the apparatus 1 for different frequency ranges or frequency subbands SB. As can be seen in FIG. 9, a number of different frequency subbands SB1, SB2, SB3, SB4 can be provided corresponding to the number of loudspeaker pairs. For example, the apparatus 1 shown in the implementation of FIG. 8 comprises four loudspeaker pairs 7, 8, 9, 11 provided for different frequency subbands SB as shown in FIG. 9. A distance d between loudspeakers of a dipole sound emitting loudspeaker pair such as the loudspeaker pairs 7, 8, 11 does increase with lowering centre frequency fc of the respective frequency subband SB for which the respective dipole sound emitting loudspeaker pair is provided. Accordingly, in the implementation shown in FIG. 8 the loudspeakers 11-1, 11-2 of the loudspeaker pair 11 are spaced apart at the distance d3, d3 being the largest distance of the distances d1 to d3 associated to the loudspeaker pairs pointing towards the user U, and are provided for the frequency subband SB having the lowest centre frequency fc, i.e. the frequency band SB1 shown in FIG. 9. The loudspeakers 8-1, 8-2 for a dipole sound emission are spaced apart as a distance d2 and are provided in the shown implementation for the frequency subband SB2 shown in FIG. 9. The loudspeakers 7-1, 7-2 of the loudspeaker pair 7 provided for dipole sound emission are provided for the frequency subband SB3 as shown in FIG. 9. The loudspeakers 9-1, 9-2 pointing to the left and right are provided for generating an acoustic signal in a high frequency band SB4 shown in FIG. 9. As can be seen from the diagram in FIG. 9, for low and medium frequencies, i.e. for the frequency subbands SB1, SB2, SB3, loudspeaker pairs (LSP) 11, 8, 7 are used having a dipole sound emission because of the bandwidth limitation of the filtered difference audio signals D′. With increasing frequency the distance d between the loudspeakers of the loudspeaker pairs 11, 8, 7 is lowered. For example, the loudspeakers 7-1, 7-2 provided for the subband SB3 are closest whereas the loudspeakers 11-1, 11-2 provided for the lowest frequency subband SB1 are spaced apart at the maximum distance d3 as can be seen in FIG. 8.

The filters 10-1, 10-2 and 10-3 are adapted to equalize a diffuse frequency response of the loudspeaker pairs. In an alternative implementation, this equalization of the diffuse frequency response of the loudspeaker pairs is obtained by the filters of the signal filter bank 4 which are adapted to integrate this equalization together with the band limiting. The higher the frequency, the closer the loudspeakers of loudspeaker pairs are positioned to each other. This is possible because with increasing frequency the directivity of the loudspeakers is increased. This is, for example, shown in the diagram of FIG. 15.

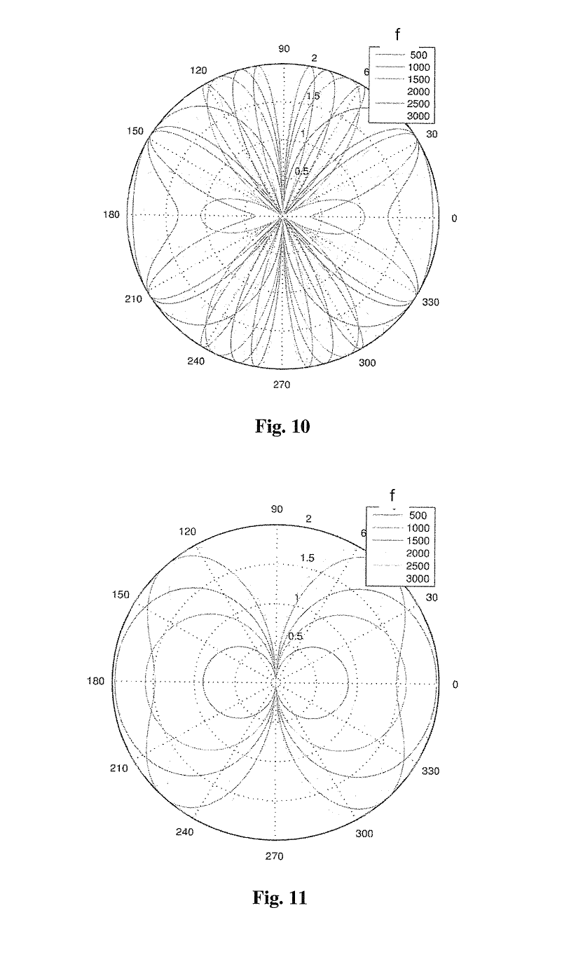

FIG. 10 shows a diagram for illustrating directional characteristics of a loudspeaker pairs of a dipole sound emission when the two loudspeakers are spaced apart at a distance of 0.1 m.

As can be seen from FIG. 10 the loudspeaker pair shows a good performance at a low frequency of e.g. 500 Hz whereas the performance is degraded with increasing frequency, for example at a frequency of f=3 kHz where the lobes point to all directions without any left/right directivity.

FIG. 11 shows a further diagram for illustrating a directional characteristic loudspeaker pair for dipole sound emission where the loudspeakers are spaced apart at a distance d=40 cm/0.4 m.

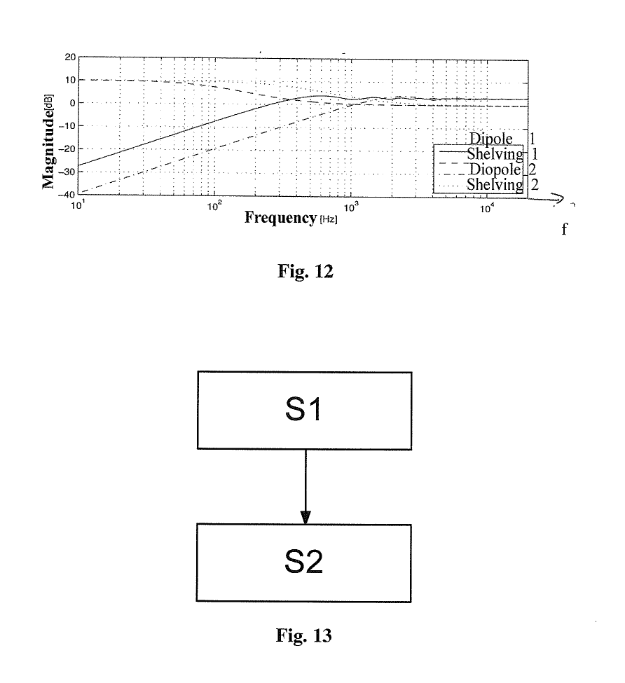

FIG. 12 shows a diagram for illustrating a diffuse field response of two pairs of loudspeakers for a dipole sound emission at a distance d=10 cm and at a distance d=40 cm. The frequency responses of corresponding shelving filters for flattening the diffuse field response of the dipole sound emitting loudspeaker pairs are also shown. The shelving correction filters are compensation filters and can be implemented by the filters 10-i shown in FIG. 6.

FIG. 13 shows a flow chart of a possible implementation of a method for generating an acoustic signal with an enhanced spatial effect according to a fourth aspect of the present application.

As can be seen from FIG. 13 the method comprises a first step S1 where a difference audio signal D is filtered according to a filter characteristic to limit a bandwidth of the difference audio signal.

In a second step S2 the bandwidth limited difference audio signal D′ is applied to at least one pair of loudspeakers for dipole sound emission.

In a possible implementation the method shown in FIG. 13 can be implemented by a signal processing software. In the implementation of the method as shown in FIG. 13 the bandwidth limited difference audio signal D′ is inverted before being applied to a first loudspeaker pair of loudspeakers for dipole sound emission but is applied directly to a second loudspeaker of this pair of dipole sound emitting loudspeakers. In a possible implementation the difference audio signal D filtered in step S1 is calculated by subtracting a first audio signal from a second audio signal to provide this difference audio signal D. The first and second audio signal can be formed by a left and right audio signal of a stereo audio signal. In a possible implementation the difference audio signal D is filtered with a filter characteristic which can be adjusted by a control unit connected to a user interface of a user U listening to the generated acoustic sound signal. In a possible implementation of the method the two loudspeakers of the loudspeaker pair provided for dipole sound emission are spaced apart at a distance d and can be moved around a symmetry axis, wherein the distance d is adjusted depending on a centre frequency of the frequency subband SB of the dipole sound emitting loudspeaker pair provided for the respective frequency subband SB. The distance d between the loudspeakers of the dipole sound emitting loudspeaker pair can be increased in a possible implementation with lowering centre frequency fc of the respective frequency subband SB.

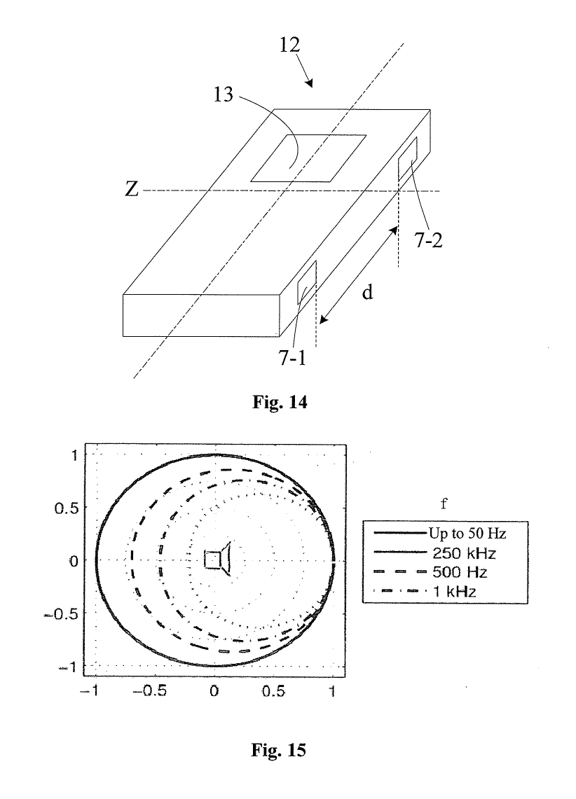

FIG. 14 shows a perspective view on a mobile device 12 according to a second aspect of the present application comprising an apparatus 1 for generating an acoustic signal with an enhanced spatial effect according to a first aspect of the present application. The mobile device 12 can be formed for example by a mobile phone. The mobile device 12 can also e.g. be a smartphone or a tablet. According to the implementation of FIG. 14 the mobile device 12 is formed by a mobile phone having a display 13 as shown in FIG. 14. The mobile device 12 has loudspeakers 7-1, 7-2 provided for dipole sound emission which are spaced apart at a distance d around a symmetry axis Z. The embodiment as shown in FIG. 14 corresponds to the embodiment shown in FIG. 3. In a possible implementation a loudspeaker pair 7 comprising loudspeakers 7-1, 7-2 is provided at one side of the mobile device 12. Ina further possible implementation two pairs of dipole sound emitting loudspeakers are provided on both sides of the mobile device 12. In a further possible implementation two pairs of dipole sound emitting loudspeakers are provided on both sides, the left and right side, of a front side of the mobile device, wherein the front side is, for example, the side comprising the display 13 and the symmetry axis Z is orthogonal to the surface of the display. The mobile device 12 enhances the sound experience of the generated acoustic signal with an enhanced spatial effect. The sound can be for example music or sounds of a computer game or a ringing sound. The mobile device 12 can also comprise several loudspeaker pairs for dipole sound emission on both sides of its casing and/or on both sides, the left and right side, of a front side of the mobile device. Further, it is possible that the mobile device 12 further comprises a loudspeaker pair 9 as shown in FIGS. 5, 8 of the top and/or bottom side of the mobile device 12.

The apparatus 1 according to the first aspect of the present application can also be implemented in a sound bar, in particular a sound bar for rendering a 5.1 surround audio signal. It is possible to apply a stereo downmix to the 5.1 surround signal to use the sound bar according to the third aspect of the present application comprising an apparatus 1 for generating an acoustic signal with an enhanced spatial effect. It is further possible to treat a centre C, and left and right surround channels L_{S} and R_{S} differently. For example, the sound signal L_{S}+R_{S} can be the same as a low path filtered difference signal as no low path filtering is applied to the L_{S}+R_{S} to render a full band surround channel. In a possible implementation the centred channel C can be gain adjusted by e.g. −3 or −6 dB before being applied to the two centre loudspeakers of the sound bar.

According to a fifth aspect of the present application a virtual surround audio system for rendering 5.1, 7.1 or other multi-channel audio content is provided comprising at least one apparatus 1 for generating an acoustic signal with an enhanced spatial effect according to a first aspect of the present application.

FIG. 15 shows a diagram for illustrating a directivity increase of a loudspeaker. This effect is exploited by the apparatus 1 according to the first aspect of the present application. As can be seen from FIG. 15 at a low frequency of up to 50 Hz there is almost no directivity of the loudspeaker. By increasing the frequency for example to 1 kHz the directivity increases and the sound emission is directed to a certain direction. The loudspeaker pairs mimicking a dipole loudspeaker and being provided for dipole sound emission are similar in concept as pressured gradient microphones and aim a reproducing a sound pressured gradient in a specific direction. The sound field of a plane wave can be expressed by the following equation:

p(x,y,z,t)=Pe^{j(ωt+k}^{ₓ}^{x+k}^{_{y}}^{y+k}^{_{z}}^{z)}, (1)

where

p is the complex amplitude and

kₓ=k cos φ cos γ

k_{y}=k sin φ cos γ

k_{z}=k sin γ, (2)

wherein k=w/c, c being the speed of sound in air.

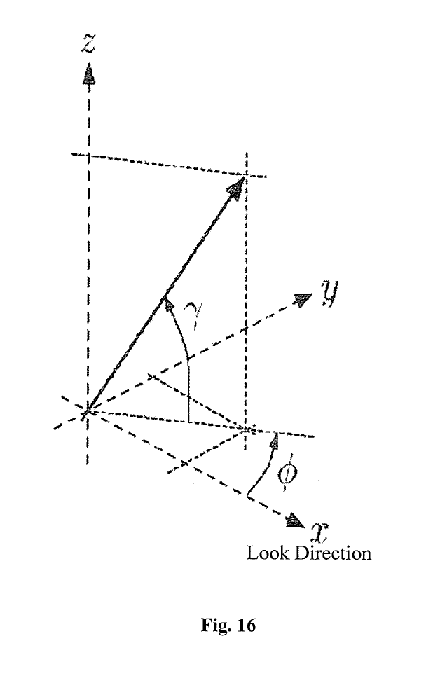

The definition of the used coordinate system comprising the angles φ and γ is illustrated in FIG. 16. A first derivative of the sound pressure of the plane wave in X-direction is given by:

$$\begin{matrix}{p}_{x} ( x , y , z , t ) = \frac{δ p ( x , y , z , t )}{δ x} \\ = j k cos φ cos γ p ( x , y , z , t ) .\end{matrix} \qquad ( 3 )$$

Accordingly, the directional response DIR is given by:

$$DIR ( φ , γ , j ω ) = \frac{jω}{c} cos φ cos γ . \qquad ( 4 )$$

and the directional response DIR is axially symmetric relative to the X-axis. Thus, it is fully specified by the directional response in the horizontal plane (z=0), i.e.

$$DIR ( φ , j ω ) = \frac{jω}{c} cos φ . \qquad ( 5 )$$

Compared to reproducing a sound pressure the reproduction of a sound pressured derivative has a first order high-pass filter characteristic.

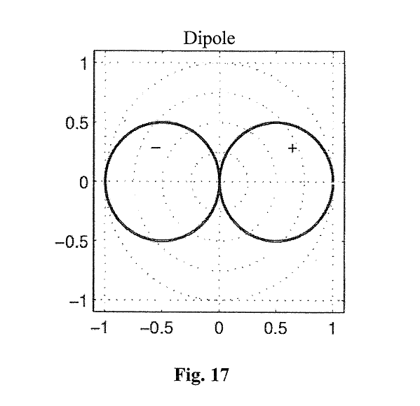

FIG. 17 shows a directional response of a loudspeaker pair emitting dipole sound emission.

It is possible to approximate the sound field gradient by a differential of the sound field at two points. All field gradients in the X-direction can be approximated by the differential

$$p ( x + \frac{d}{2} , y , z , t ) - p ( x - \frac{d}{2} , y , z , t )$$

where d is the distance between two measurement points. The reproduction of this differential can be written as:

$${p}_{x} ( x , y , z , t ) = 2 j sin ( \frac{ω}{2 c} d cos φ ) p ( x , y , z , t ) / d \qquad ( 6 )$$

At low frequency this equation 6 can be approximated by:

$${p}_{x} ( x , y , z , t ) \approx \frac{jω}{c} cos φ p ( x , y , z , t ) , \qquad ( 7 )$$

A filter with a frequency response

$$\frac{c}{jω}$$

has a frequency-independent dipole response (coss).

As can be seen from the above equation (7) up to a factor d the differential approximation is equal to the true derivative expressed by equation (5), both correspond to an ideal dipole direction response with first order high-pass characteristic.

The method and apparatus according to the present application can be used for a wide range of applications. For instance, it can be implemented in a sound bar of an audio system. The apparatus and method according to the present application can be implemented in a mobile device such as a mobile device shown in FIG. 14. The method of apparatus according to the present application can be used for indoor or outdoor applications as well.

The signal filter bank 4 of the apparatus 1 can be implemented by a chip. Into this chip also the filters 10-i shown for example in FIG. 6 can be integrated. In a possible implementation of the apparatus 1 as shown in FIG. 6 comprising a subtractor 3, signal adders 6 as well as inverters and the filter bank can be integrated in the same chip.

The apparatus 1 defines different reproduction techniques such that for each signal type and frequency range an optimal working technique is used. In a possible implementation the centre frequencies of the frequency subbands SB can be adjusted. In a possible implementation with frequency subbands can also overlap each other. In an alternative implementation the frequency subbands SB can be spaced apart having a gap frequency band between the frequency subbands. In a further possible implementation the frequency subbands SB can be shifted in frequency.

The apparatus 1 for generating an acoustic signal with an enhanced spatial effect can receive the input audio signals from any kind of audio signal source. The signal source can for instance be a stereoplayer outputting a music stereo audio signal. Further, the input audio signal can be output by a microphones or a group of microphones. Further, it is possible that the input audio signal applied to the apparatus 1 according to the first aspect of the present application is provided by a transceiver receiving signal via an air link from a base station. Further, it is possible that the input audio signal is read from a memory device storing audio signals. The application of the input audio signals applied to the apparatus 1 can be controlled by a control unit.

What is claimed is:

1. An apparatus for generating an acoustic signal with an enhanced spatial effect, the apparatus comprising:
at least one signal filter bank adapted to filter a difference audio signal with a filter characteristic to limit a bandwidth of the difference audio signal; and
wherein the bandwidth limited difference audio signal is applied to at least one pair of loudspeakers for dipole sound emission.

2. The apparatus according to claim 1, wherein the bandwidth limited difference audio signal is inverted before being applied to a first loudspeaker of the at least one pair of loudspeakers and applied directly to a second loudspeaker of the at least one pair of loudspeakers.

3. The apparatus according to claim 1, further comprising:
a signal subtractor adapted to subtract a first audio signal from a second audio signal to provide the difference audio signal.

4. The apparatus according to claim 1, wherein the at least one signal filter bank comprises filters each being adapted to filter an associated frequency subband of the difference audio signal.

5. The apparatus according to claim 4, wherein for each frequency subband of the at least one signal filter bank a corresponding pair of loudspeakers is provided.

6. The apparatus according to claim 5, wherein:
the bandwidth limited difference audio signal output by a filter of the at least one signal filter bank provided for a low frequency subband is subtracted from the first audio signal to provide a first input audio signal for the first loudspeaker of the dipole sound emitting loudspeaker pair; and
the bandwidth limited difference audio signal output by a filter of the at least one signal filter bank provided for a low frequency subband is added to the second audio signal to provide a second input audio signal for the second loudspeaker of the dipole sound emitting loudspeaker pair.

7. The apparatus according to claim 5, wherein the bandwidth limited difference audio signal output by a filter of the at least one signal filter bank provided for a high frequency subband is applied directly to a further loudspeaker pair comprising left and right pointing loudspeakers.

8. The apparatus according to claim 1, wherein the filters of the at least one signal filter bank comprise Infinite Impulse Response (IIR) filters or Finite Impulse Response (FIR) filters.

9. The apparatus according to claim 1, wherein the filters of the at least one signal filter bank are adapted to equalize a diffuse frequency response of the loudspeaker pairs.

10. The apparatus according to claim 1, wherein to each filter of the signal filter bank a further filter is connected in series.

11. The apparatus according to claim 1, wherein:
the two loudspeakers of a loudspeaker pair are spaced apart at a predetermined distance around a symmetry axis; and
a centre frequency of the frequency subband of the dipole sound emitting loudspeaker pair provided for the respective frequency subband is set depending on the predetermined distance.

12. The apparatus according to claim 11, wherein the centre frequency of the frequency subband of the dipole sound emitting loudspeaker pair provided for the frequency subband is lowered with increasing distance between the loudspeakers of the dipole sound emitting loudspeaker pair.

13. The apparatus according to claim 1, wherein the at least one signal filter bank comprises a predetermined filter characteristic or an adjustable filter characteristic.

14. A mobile device, comprising:
an apparatus for generating an acoustic signal with an enhanced spatial effect, the apparatus comprising:
at least one signal filter bank adapted to filter a difference audio signal with a filter characteristic to limit a bandwidth of the difference audio signal; and
wherein the bandwidth limited difference audio signal is applied to at least one pair of loudspeakers for dipole sound emission.

15. A soundbar, comprising:
an apparatus for generating an acoustic signal with an enhanced spatial effect, the apparatus comprising:
at least one signal filter bank adapted to filter a difference audio signal with a filter characteristic to limit a bandwidth of the difference audio signal; and
wherein the bandwidth limited difference audio signal is applied to at least one pair of loudspeakers for dipole sound emission.

16. A method for generating an acoustic signal with an enhanced spatial effect, the method comprising:
filtering a difference audio signal with a filter characteristic to limit a bandwidth of the difference audio signal; and
applying the bandwidth limited difference audio signal to at least one pair of loudspeakers for dipole sound emission.
